(19) United States
(12) Patent Application Publication
(10) Pub. No.: US 2004/0058157 A1
(43) Pub. Date: Mar. 25, 2004

(54) Gas barrier film

(75) Inventor: Shun-ichi Ishikawa, Minamiashigara-shi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/606,236

(22) Filed: Jun. 26, 2003

(30) Foreign Application Priority Data
Jun. 27, 2002 (JP) 188063/2002

(51) Int. Cl. B32B 19/02; B32B 27/20

(52) U.S. Cl. 428/411.1; 428/1.5; 427/384

(57) ABSTRACT

Disclosed is a gas barrier film having an inorganic coating layer formed by the sol-gel method or an organic-inorganic hybrid coating layer formed by the sol-gel method on a transparent base film having a glass transition temperature of 100° C. or higher and a linear thermal expansion coefficient of 40 ppm/° C. or lower. There is provided a transparent plastic film showing superior heat resistance and gas barrier property.

### TECHNICAL FIELD

The present invention relates to a transparent film showing superior heat resistance and gas barrier property. In particular, the present invention relates to a gas barrier film suitably used in an organic EL device or liquid crystal display device using a flexible support.

### RELATED ART

With the wide spread of personal computers and portable information terminals, the demand for a thin and light electronic display is rapidly increasing. A glass substrate is mainly used in the liquid crystal display devices, which are currently most widely spread, and the organic EL devices, which draw attentions because of its high visibility due to the self-coloring property. However, if flexible plastic substrates can be used, it would be very preferable in view of production of lighter devices, impact resistance, flexibility thereof and so forth.

However, plastic substrates have poorer heat resistance and gas barrier property compared with glass substrates. As a result, they suffer from disadvantages that troubles may occur particularly when a high definition pattern is formed and that durability is degraded.

Japanese Patent Laid-open Publication (Kokai) No. 2001-205743 discloses an example of use of a plastic substrate having a multilayer structure constituted by layers comprising layered compounds in a liquid crystal display device, and describes that heat resistance, hardness and anti-gas permeability are improved by the use of the layered compounds. However, the gas barrier property described therein is not sufficient.

Japanese Patent Laid-open Publication (Kokai) No. 2000-323273 discloses an example of use of a film obtained by laminating a silicon oxide thin film and an organic-inorganic hybrid film formed by the sol-gel method on a polyethylene terephthalate (PET) film in a base and a protective layer for organic EL devices. However, since the glass transition temperature of PET is 100° C. or lower, it has a problem concerning heat resistance.

### SUMMARY OF THE INVENTION

In consideration of these problems in the conventional techniques, an object of the present invention is to provide a transparent plastic film showing superior heat resistance and gas barrier property. The object is, in particular, to provide a film that can realize high definition and high durability when it is used in a liquid crystal display device or an organic EL device using a flexible support.

The inventors of the present invention conducted various researches, and as a result, they found that the aforementioned object could be achieved by using the gas barrier film of the present invention described below.

(1) A gas barrier film having an inorganic coating layer formed by the sol-gel method or an organic-inorganic hybrid coating layer formed by the sol-gel method on a transparent base film having a glass transition temperature of 100° C. or higher and a linear thermal expansion coefficient of 40 ppm/° C. or lower.

(2) A gas barrier film having an inorganic coating layer formed by the sol-gel method on a transparent base film having a glass transition temperature of 100° C. or higher and a linear thermal expansion coefficient of 40 ppm/° C. or lower.

(3) A gas barrier film having an organic-inorganic hybrid coating layer formed by the sol-gel method on a transparent base film having a glass transition temperature of 100° C. or higher and a linear thermal expansion coefficient of 40 ppm/° C. or lower.

(4) A gas barrier film having an inorganic thin film layer and an organic-inorganic hybrid coating layer formed by the sol-gel method on a transparent base film having a glass transition temperature of 100° C. or higher and a linear thermal expansion coefficient of 40 ppm/° C. or lower.

(5) The gas barrier film according to (4), wherein the inorganic thin film layer is an inorganic coating layer formed by the sol-gel method.

(6) The gas barrier film according to any one of (1) to (5), wherein the transparent base film having a glass transition temperature of 100° C. or higher and a linear thermal expansion coefficient of 40 ppm/° C. or lower contains an inorganic layered compound.

(7) The gas barrier film according to (4), wherein the transparent base film having a glass transition temperature of 100° C. or higher and a linear thermal expansion coefficient of 40 ppm/° C. or lower contains an inorganic layered compound and has an inorganic thin film layer formed on the base film by a method other than the sol-gel method.

(8) The gas barrier film according to (4), wherein the transparent base film having a glass transition temperature of 100° C. or higher and a linear thermal expansion coefficient of 40 ppm/° C. or lower contains an inorganic layered compound and has a laminated structure of an inorganic thin film layer and organic-inorganic hybrid coating layer formed by the sol-gel method on the base film.

(9) The gas barrier film according to any one of (1) to (8), wherein the transparent base film has a glass transition temperature within the range of 100° C. to 300° C.

(10) The gas barrier film according to any one of (1) to (8), wherein the transparent base film has a glass transition temperature within the range of 120° C. to 250° C.

(11) The gas barrier film according to any one of (1) to (8), wherein the transparent base film has a glass transition temperature within the range of 150° C. to 250° C.

(12) The gas barrier film according to any one of (1) to (11), wherein the transparent base film has a linear thermal expansion coefficient within the range of 5 ppm/° C. to 40 ppm/° C.

(13) The gas barrier film according to any one of (1) to (11), wherein the transparent base film has a linear thermal expansion coefficient within the range of 5 ppm/° C. to 30 ppm/° C.

(14) The gas barrier film according to any one of (1) to (11), wherein the transparent base film has a linear thermal expansion coefficient within the range of 10 ppm/° C. to 20 ppm/° C.

(15) A substrate having the gas barrier film according to any one of (1) to (14).

(16) A display device having the gas barrier film according to any one of (1) to (14).

(17) An organic electroluminescent device having the gas barrier film according to any one of (1) to (14).

(18) A liquid crystal device having the gas barrier film according to any one of (1) to (14).

(19) A method for preparing a gas barrier film having an inorganic coating layer or an organic-inorganic hybrid coating layer on a transparent base film having a glass transition temperature of 100° C. or higher and a linear thermal expansion coefficient of 40 ppm/° C. or lower, which comprises the step of forming the inorganic coating layer on the transparent base film by hydrolizing and polycondensating a metal alkoxide, or the step of forming the organic-inorganic hybrid coating layer on the transparent base film by hydrolizing and polycondensating a metal alkoxide in the presence of a resin.

(20) A method for preparing a gas barrier film having an inorganic coating layer and an organic-inorganic hybrid coating layer on a transparent base film having a glass transition temperature of 100° C. or higher and a linear thermal expansion coefficient of 40 ppm/° C. or lower, which comprises the step of forming the inorganic coating layer on the transparent base film by hydrolizing and polycondensating a metal alkoxide, and the step of forming the organic-inorganic hybrid coating layer on the transparent base film by hydrolizing and polycondensating a metal alkoxide in the presence of a resin.

According to the present invention, a transparent plastic film showing superior heat resistance and gas barrier property can be provided. By using this plastic film, liquid crystal display devices, organic EL devices and so forth with high definition and superior durability can be provided.

### BEST MODE FOR CARRYING OUT THE INVENTION

Hereafter, the gas barrier film of the present invention will be explained in detail. In the present specification, ranges indicated with “−” mean ranges including the numerical values before and after “−” as the minimum and maximum values.

The gas barrier film of the present invention is first characterized in that a highly heat-resistant transparent plastic film having a glass transition temperature of 100° C. or higher and a linear thermal expansion coefficient of 40 ppm/° C. or lower is used as a support. The glass transition temperature is more preferably 120° C. or higher, particularly preferably 150° C. or higher. The linear thermal expansion coefficient is more preferably 30 ppm/° C. or lower, particularly preferably 20 ppm/° C. or lower.

Examples of a plastic material that has a glass transition temperature (Tg) of 100° C. or higher and can be a transparent film include, for example, polyethylene naphthalate (Tg: 115° C.), polycarbonate (Tg: 160° C.), cycloolefin polymer (Tg: 163° C., for example), polyalylate (Tg: 193° C.), polyethersulfone (Tg: 225° C.) and so forth. However, these materials except for polyethylene naphthalate have a slightly high linear thermal expansion coefficient.

When the linear thermal expansion coefficient is high, the linear thermal expansion coefficient can be reduced by adding an inorganic layered compound in a cleaved state to the base.

In this case, only one kind of inorganic layered compound may be used, or optional two or more kinds of such compounds may be mixed and used. As the inorganic layered compound, clay minerals having swelling property and/or cleavage property, hydrotalcite compounds and other similar compounds are particularly preferably used.

More specific examples of such clay minerals includes kaolinite, dickite, nacrite, halloysite, antigorite, chrysotile, pyrophyllite, montmorillonite, beidellite, nontronite, saponite, sauconite, stevensite, hectorite, tetrasilylic mica, sodium taeniolite, muscovite, margarite, talc, vermiculite, phlogopite, xanthophyllite, chlorite and so forth.

Further, not only natural clay minerals, but also synthetically produced clay minerals can be preferably used. In particular, synthetic fluorine tetrasilicon mica known as a swellable mica is preferred because of its high aspect ratio after swelling and cleavage, which results in greater effect.

In the present invention, there can also be preferably used inorganic layered compounds (for example, layered silicates) in which positive ions (sodium, potassium, lithium etc.) carried between layers thereof are replaced with organic cations.

The cation exchange capacity (CEC) of a layered compound is preferably 25-200 milliequivalents/100 g, more preferably 50-150 milliequivalents/100 g.

As the organic cations used, alkylammonium ions containing a long-chain alkyl group are preferred. Examples thereof include tetrabutylammonium ion, tetrahexylammonium ion, dihexyldimethylammonium ion, dioctyldimethylammonium ion, hexyltrimethylammonium ion, octyltrimethylammonium ion, dodecyltrimethylammonium ion, hexadecyltrimethylammonium ion, octadecyltrimethylammonium ion, dioctadecyldimethylammonium ion, docosenyltrimethylammonium ion, hexadecyltrimethylammonium ion, tetradecyldimethylbenzylammonium ion, octadecyldimethylbenzylammonium ion, dioleyldimethylammonium ion, polyoxyethylene dodecylmonomethylammonium ion and so forth.

The amount of the organic cation used is not specifically defined. The amount is preferably 0.05 to 3 equivalents, more preferably 0.1 to 2.5 equivalents, still more preferably 0.5 to 2 equivalents relative to the ion equivalent of the ion-exchangable inorganic ion in the layered silicates.

As a method for making an inorganic layered compound organic, a wet method is generally used. That is, an inorganic layered compound is sufficiently solvated with water, alcohol or the like, then added with organic cations and stirred so that organic cations should substitute for metal ions between layers in the inorganic layered compound. Then, unsubstituted organic cations are sufficiently washed off, and the compound is taken by filtration and dried. In addition, it is also possible that the inorganic layered compound and organic cations are directly reacted in an organic solvent, or the inorganic layered compound and organic cations are reacted by heating and kneading them in the presence of a resin or the like in an extruder.

In the present invention, by melt-kneading the layered compound made organic obtained as described above and the target resin, or mixing them in a solution, a composition in which the inorganic layered compound in a cleaved state is dispersed in a resin can be obtained. Among these methods, the melt-kneading method is preferred also in view of the process and costs. Further, as the melt-kneading apparatus, kneading apparatuses generally used for thermoplastic resins can be used. For example, single or double screw kneading extruder, roller, Banbury mixer and so forth may be used.

The ratio of the layered compound and the resin is preferably 1/100 to 100/20, more preferably 5/100 to 100/50, in terms of a weight ratio.

The aforementioned resin composition can be made into a film by usual melt-extruding method, calendering method, solution casting method or the like. Further, this film can also be monoaxially or biaxially stretched.

The film surface may be subjected to corona discharge treatment, glow discharge treatment, UV treatment, plasma treatment or the like to improve adhesion with a coating layer. An anchor layer may also be provided.

The thickness of the base film used in the present invention is preferably 5-500 μm, more preferably 5-200 μm, still more preferably 10-100 μm. When the base film is unduly thin, strength becomes insufficient, and handling becomes difficult. When the film is unduly thick, transparency and flexibility tend to be degraded.

The present invention is secondly characterized by use of a dense coating layer formed by the sol-gel method. This can provide a film having a high gas barrier property.

The coating layer of the present invention may consist of a single layer or multiple layers. The thickness thereof is preferably 50 nm to 100 μm, more preferably 100 nm to 50 μm. When the coating layer is unduly thin, the barrier property is degraded. When the coating layer is unduly thick, transparency tends to be degraded, and cracks tend to occur, resulting in easy breakage.

In the sol-gel method used in the present invention, a metal alkoxide is preferably hydrolyzed and polymerized by condensation in a solution or a coated film to obtain a dense thin film. In this operation, an organic-inorganic hybrid material may also be obtained by using a resin in combination. The term “organic-inorganic hybrid” used in the present invention means a material in which an organic component and a metal compound, in particular, a metal oxide, are at least in a molecular dispersion state.

As the metal alkoxide, alkoxysilanes and/or metal alkoxides other than alkoxysilane can be preferably used. As the metal alkoxides other than alkoxysilane, zirconium alkoxides, titanium alkoxides, aluminum alkoxides and so forth are preferred.

The alkoxysilanes preferably used in the present invention will be further explained. Examples thereof include alkoxysilanes represented by the following formula.

Si(OR¹)ₓ(R²)₄₋ₓ

In the above formula, R¹ preferably represents an alkyl group having 1-5 carbon atoms or an acyl group having 1-4 carbon atoms. Examples include, for example, methyl group, ethyl group, n-propyl group, isopropyl group, n-butyl group, sec-butyl group, tert-butyl group, acetyl group and so forth. R² preferably represents an organic group having 1-10 carbon atoms. Examples include, for example, an unsubstituted hydrocarbon group such as methyl group, ethyl group, n-propyl group, isopropyl group, n-butyl group, tert-butyl group, n-hexyl group, cyclohexyl group, n-octyl group, tert-octyl group, n-decyl group, phenyl group, vinyl group and allyl group and a substituted hydrocarbon group such as γ-chloropropyl group, CF₃CH₂—, CF₃CH₂CH₂—, C₂F₅CH₂CH₂—, C₃F₇CH₂CH₂CH₂—, CF₃OCH₂CH₂CH₂—, C₂F₅OCH₂CH₂CH₂—, C₃F₇OCH₂CH₂CH₂—, (CF₃)₂CHOCH₂CH₂CH₂—, C₄F₉CH₂OCH₂CH₂CH₂—, 3-(perfluorocyclohexyloxy)propyl group, (CF₂)₄CH₂OCH₂CH₂CH₂—, H (CF₂)₄CH₂CH₂CH₂—, γ-glycidoxypropyl group, γ-mercaptopropyl group, 3,4-epoxycyclohexylethyl group and γ-methacryloyloxypropyl group. X is preferably an integer of 2-4.

Specific examples of these alkoxysilanes are shown below. Examples of the compounds where x=4 include tetramethoxysilane, tetraethoxysilane, tetra-n-propoxysilane, tetraisopropoxysilane, tetra-n-butoxysilane, tetraacetoxysilane and so forth.

Examples of the compounds where x=3 include methyltrimethoxysilane, methyltriethoxysilane, ethyltrimethoxysilane, ethyltriethoxysilane, n-propyltrimethoxysilane, n-propyltriethoxysilane, isopropyltrimethoxysilane, isopropyltriethoxysilane, γ-chloropropyltrimethoxysilane, γ-chloropropyltriethoxysilane, γ-glycidoxypropyltrimethoxysilane, γ-glycidoxypropyltriethoxysilane, γ-methacryloyloxypropyltrimethoxysilane, γ-mercaptopropyltriethoxysilane, phenyltrimethoxysilane, vinyltriethoxysilane, 3,4-epoxycyclohexylethyltrimethoxysilane, 3,4-epoxycyclohexylethyltriethoxysilane, CF₃CH₂CH₂Si(OCH₃)₃, C₂F₅CH₂CH₂Si(OCH₃)₃, C₂F₅OCH₂CH₂CH₂Si(OCH₃)₃, C₃F₇OCH₂CH₂CH₂Si(OC₂H₅)₃, (CF₃)₂CHOCH₂CH₂CH₂Si(OCH₃)₃, C₄F₉CH₂OCH₂CH₂CH₂Si(OCH₃)₃, H (CF₂)₄CH₂OCH₂CH₂CH₂Si(OCH₃)₃, 3-(perfluorocyclohexyloxy)propyltrimethoxysilane and so forth.

Examples of the compounds where x=2 include dimethyldimethoxysilane, dimethyldiethoxysilane, methylphenyldimethoxysilane, diethyldimethoxysilane, diethyldiethoxysilane, di-n-propyldimethoxysilane, di-n-propyldiethoxysilane, diisopropyldimethoxysilane, diisopropyldiethoxysilane, diphenyldimethoxysilane, divinyldiethoxysilane, (CF₃CH₂CH₂)₂Si(OCH₃)₂, (C₃F₇OCH₂CH₂CH₂)₂Si(OCH₃)2, [H(CF₂)₆CH₂OCH₂CH₂CH₂]₂Si(OCH₃)₂, (C₂F₅CH₂CH₂)₂Si(OCH₃)₂ and so forth.

The polymers used in combination for the sol-gel reaction preferably have a hydrogen bond-forming group. Examples of resins having a hydrogen bond-forming group include polymers having a hydroxyl group and derivatives thereof (polyvinyl alcohol, polyvinyl acetal, ethylene-vinyl alcohol copolymer, phenol resin, methylol melamine etc. and derivatives thereof); polymers having a carboxyl group and derivatives thereof (homopolymers or copolymers containing units of a polymerizable unsaturated acid such as poly(meth)acrylic acid, maleic anhydride acid and itaconic acid, esters of these polymers (homopolymers or copolymers containing units of a vinyl ester such as vinyl acetate, (meth)acrylic acid ester such as methyl methacrylate or the like) etc.); polymers having an ether bond (polyalkylene oxide, polyoxyalkylene glycol, polyvinyl ether, silicon resin etc.); polymers having an amide bond (N-acylated polyoxazoline and polyalkyleneimine having a >N(COR)— bond (in the formula, R represents hydrogen atom, an alkyl group which may be substituted or an aryl group which may be substituted)); polyvinylpyrrolidine having a >NC(O)— bond and derivatives thereof; polyurethane having a urethane bond; polymers having a urea bond and so forth.

Further, polymers containing silyl group may also be used. The polymer containing silyl group comprises a backbone polymer and has at least one, preferably two or more, of silyl groups having a silicon atom bonded to a hydrolyzable group and/or hydroxyl group at its end or side chain in one molecule of the polymer. A preferred structure of the silyl group is represented by the following formula.

—Si(R³)₃₋ₐ(X)ₐ

In the above formula, X represents a hydrolyzable group such as a halogen atom, an alkoxy group, an acyloxy group, aminoxy group, phenoxy group, a thioalkoxy group and an amino group and/or a hydroxyl group, R³ represents hydrogen atom, an alkyl group having 1-10 carbon atoms or an aralkyl group having 7-10 carbon atoms, and a is an integer of 1-3.

As the polymers containing silyl group, vinyl polymers containing silyl group whose backbone comprises a vinyl polymer are particularly preferred. In general, these polymers can be readily synthesized by the following methods. However, the method for producing such polymers is not limited to these methods.

(a) A hydrosilane compound is reacted with a vinyl polymer having a carbon-carbon double bond.

(b) A silane compound represented by the following formula:

R⁴—Si(R³)₃₋ₐ(X)ₐ

(wherein X, R³ and a have the same meanings as defined above, and R⁴ represents an organic group having a polymerizable double bond) and various vinyl compounds are polymerized.

Examples of the hydrosilane compounds used in the production method described in the above (a) include halogenated silanes such as methyldichlorosilane, trichlorosilane and phenyldichlorosilane; alkoxysilanes such as methyldiethoxysilane, methyldimethoxysilane, phenyldimethoxysilane, trimethoxysilane and triethoxysilane; acyloxysilanes such as methyldiacetoxysilane, phenyldiacetoxysilane and triacetoxysilane; and aminosilanes such as methyldiaminoxysilane, triaminoxysilane, dimethylaminoxysilane and triaminosilane.

Further, the vinyl polymers used in the production method described in the above (a) are not particularly limited except that vinyl polymers containing hydroxyl group are excluded. Preferred examples thereof include vinyl polymers obtained by copolymerizing a vinyl compound selected from (meth)acrylate esters such as methyl (meth)acrylate, ethyl (meth)acrylate, butyl (meth)acrylate, isobutyl (meth)acrylate, 2-ethylhexyl (meth)acrylate, benzyl (meth)acrylate and cyclohexyl (meth)acrylate; carboxylic acids such as (meth)acrylic acid, itaconic acid and fumaric acid and acid anhydrides such as maleic anhydride; epoxy compounds such as glycidyl (meth)acrylate; amino compounds such as diethylaminoethyl (meth)acrylate and aminoethyl vinyl ether; amide compounds such as (meth)acrylamide, N-tert-butyl(meth)acrylamide, itaconic acid diamide, α-ethylacrylamide, crotonamide, fumaric acid diamide, maleic acid diamide and N-butoxymethyl(meth)-acrylamide; acrylonitrile, styrene, vinyltoluene, α-methylstyrene, vinyl chloride, vinyl acetate, vinyl propionate, N-vinylpyrrolidine etc., with a monomer having a double bond in a side chain such as allyl methacrylate.

Moreover, examples of the silane compounds used in the production method described in the above (b) include the compounds described in Japanese Patent Laid-Open Publication (Kokai) No. 2001-42102, Chemical Formula 5.

Further, as the vinyl compounds used in the production method described in the above (b), the vinyl compounds used for the polymerization of the vinyl polymer in the production method of the above (a) can be used. In addition to those mentioned for the production method described in the above (a), vinyl compounds containing a hydroxyl group such as 2-hydroxyethyl (meth)acrylate, 2-hydroxypropyl (meth)acrylate, 2-hydroxyvinyl ether or N-methylolacrylamide can also be used.

Preferred specific examples of the vinyl polymers containing silyl group described above include acrylic polymers containing trialkoxysilyl group represented by the following formula. The average molecular weight of these vinyl polymers containing silyl group is preferably 2,000-100,000, more preferably 4,000-50,000.

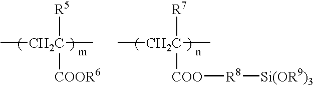

In the above formula, R⁵ and R⁷ each independently represent hydrogen atom, fluorine atom or methyl group, R⁶ represents hydrogen atom, an alkyl group having 1-12 carbon atoms (e.g., methyl group, ethyl group, n-propyl group, allyl group, n-butyl group, isobutyl group, n-pentyl group, n-hexyl group, benzyl group, an alkyl group containing a fluorine atom such as (CF₃)₂CH—, CF₃CH₂—, C₇F₁₅CH₂— and C₂F₅CH₂CH₂—), R⁸ represents an alkylene group having 1-4 carbon atoms such as methylene group, ethylene group, propylene group and butylene group, R⁹ has the same meaning as R¹ mentioned above, and n/(m+n)=0.01-0.4, preferably 0.02-0.2.

Specific examples of the vinyl polymers containing silyl group preferably used in the present invention include Kaneka Zemlac produced by Kaneka Corporation and the following polymers. However, vinyl polymers containing silyl group that can be used in the present invention are not limited to these polymers.

P-1: Methyl methacrylate/γ-acryloxypropyltrimethoxysilane copolymer (80/20 (w/w))

P-2: methyl methacrylate/γ-methacryloxypropyltrimethoxysilane copolymer (85/15 (w/w))

P-3: Methyl methacrylate/ethyl acrylate/γ-methacryloxypropyltrimethoxysilane copolymer (50/40/10 (w/w/w))

P-4: M-1/γ-methacryloxypropyltrimethoxysilane copolymer (90/10 (w/w))

P-5: M-2/γ-methacryloxypropyltrimethoxysilane copolymer (80/20 (w/w))

P-6: M-1/M-3/γ-methacryloxypropyltrimethoxysilane copolymer (50/40/10 (w/w/w))

P-7: Methyl methacrylate/methyl acrylate/γ-acryloxypropyltrimethoxysilane copolymer (60/25/15 (w/w/w))

P-8: M-1/methyl methacrylate/γ-methacryloxypropytrimethoxysilane copolymer (70/25/5 (w/w/w))

The structural formulas of M-1, M-2 and M-3 are as follows.

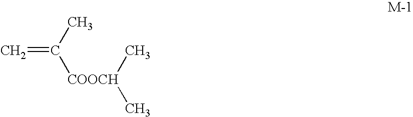

M-2

CH₂═CH COOCH₂CH₃

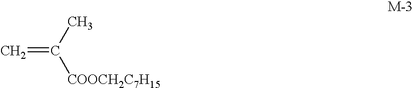

The proportion of the polymer containing silyl group in the composition is 1-200% by weight, preferably 3-100% by weight, more preferably 5-50% by weight, based on the total alkoxysilane used.

Further, a monomer may be used together in the sol-gel reaction and polymerized during the sol-gel reaction or thereafter to produce an organic-inorganic hybrid material.

During the sol-gel reaction, the metal alkoxide is hydrolyzed and polymerized by condensation in water or an organic solvent. For this reaction, it is preferable to use a catalyst. As the catalyst for hydrolysis, acids are generally used. As the acids, inorganic acids or organic acids may be used. Examples of the inorganic acids include hydrochloric acid, hydrogen bromide, hydrogen iodide, sulfuric acid, sulfurous acid, nitric acid, nitrous acid, phosphoric acid, phosphorous acid and so forth. Examples of the organic acids include carboxylic acids (formic acid, acetic acid, propionic acid, butyric acid, succinic acid, cyclohexanecarboxylic acid, octanoic acid, maleic acid, 2-chloropropionic acid, cyanoacetic acid, trifluoroacetic acid, perfluorooctanoic acid, benzoic acid, pentafluorobenzoic acid, phthalic acid etc.), sulfonic acids (methanesulfonic acid, ethanesulfonic acid, trifluoromethanesulfonic acid, p-toluenesulfonic acid, pentafluorobenzenesulfonic acid etc.), phosphoric acids and phosphonic acids (phosphoric acid dimethyl ester, phenylphosphonic acid etc.), Lewis acids (boron trifluoride etherate, scandium triflate, alkyltitanic acid, aluminic acid etc.) and heteropolyacids (phosphomolybdic acid, phosphotungstic acid etc.).

The amount of the acid used is 0.0001-0.05 mol, preferably 0.001-0.01 mol, per 1 mol of metal alkoxide (alkoxysilane+other metal alkoxide when alkoxysilane and other metal alkoxide are contained).

After the hydrolysis, basic compounds such as inorganic bases and amines may be added to adjust pH of the solution to make it close to neutral so that condensation polymerization should be promoted.

As the inorganic bases, sodium hydroxide, potassium hydroxide, calcium hydroxide, magnesium hydroxide, aluminum hydroxide, ammonia and so forth can be used. As the organic base compounds, amines (ethylenediamine, diethylenetriamine, triethylenetetramine, tetraethylenepentamine, triethylamine, dibutylamine, N,N-dimethylbenzylamine, tetramethylethylenediamine, piperidine, piperazine, morpholine, ethanolamine, diazabicycloundecene, quinuclidine, aniline, pyridine etc.) and phosphines (triphenylphosphine, trimethylphosphine etc.) can be used.

Further, it is also preferable to use, after the hydrolysis with acids, in particular, amines represented by the following formula described in Japanese Patent Application No. 2002-110061. In this case, a suitable addition amount of the amine is an equimolar amount to 100 times of the acid in mole, preferably an equimolar amount to 20 times, in mole.

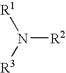

In the above formula, R¹ and R² each independently represent hydrogen atom, an aliphatic group, an acyl group, an aliphatic oxycarbonyl group, an aromatic oxycarbonyl group, an aliphatic sulfonyl group or an aromatic sulfonyl group, and R³ represents an aromatic oxy group, an aliphatic thio group, an aromatic thio group, an acyloxy group, an aliphatic oxycarbonyloxy group, an aromatic oxycarbonyloxy group, a substituted amino group, a heterocyclic group or hydroxy group. However, when R³ is not an aromatic group, either R¹ or R² or the both represent hydrogen atom.

Further, other sol-gel catalysts can be used in combination. Examples thereof will be shown below.

(1) Metal Chelate Compounds

Metal chelate compounds having a metal as the center metal and an alcohol represented by the formula R¹⁰OH (wherein R¹⁰ represents an alkyl group having 1-6 carbon atoms) and a diketone represented as R¹¹COCH₂COR¹² (wherein R¹¹ represents an alkyl group having 1-6 carbon atoms, and R¹² represents an alkyl group having 1-6 carbon atoms or an alkoxy group having 1-16 carbon atoms) as ligands can be suitably used without any particular limitation. Two or more metal chelate compounds may be used in combination so long as they are in this category. Those having Al, Ti or Zr as the center metal are particularly preferred as the metal chelate compounds of the present invention. Those selected from a group of compounds represented by the formulas Zr(OR¹⁰)ₚ₁(R¹¹COCHCOR¹²)ₚ₂, Ti(OR¹⁰)_{q1}(R¹¹COCHCOR¹²)_{q2} and Al(OR¹⁰)ᵣ₁(R¹¹COCHCOR¹²)ᵣ₂ are preferred, and they have an action of promoting the condensation reaction.

R¹⁰ and R¹¹ in the metal chelate compound may be identical or different, and represent an alkyl group having 1-6 carbon atoms, specifically, ethyl group, n-propyl group, isopropyl group, n-butyl group, sec-butyl group, tert-butyl group, n-pentyl group or the like. In addition to the aforementioned alkyl groups having 1-6 carbon atoms, R¹² also represents an alkoxy group having 1-16 carbon atoms, for example, methoxy group, ethoxy group, n-propoxy group, isopropoxy group, n-butoxy group, sec-butoxy group, tert-butoxy group, lauryl group, stearyl group or the like. In the metal chelate compound, p1, p2, q1, q2, r1 and r2 are integers determined so as to obtain quadridentate or hexadentate ligands.

Specific examples of the metal chelate compounds include zirconium chelate compounds such as tri-n-butoxy(ethyl acetoacetate) zirconium, di-n-butoxy.bis(ethyl acetoacetate) zirconium, n-butoxy.tris(ethyl acetoacetate) zirconium, tetrakis(n-propyl acetoacetate) zirconium, tetrakis(acetyl acetoacetate) zirconium and tetrakis(ethyl acetoacetate) zirconium; titanium chelate compounds such as diisopropoxy.bis(ethyl acetoacetate) titanium, diisopropoxy.bis(acetyl acetate) titanium and diisopropoxy.bis(acetylacetone) titanium; aluminum chelate compounds such as diisopropoxy(ethyl acetoacetate) aluminum, diisopropoxy(acetyl acetonate) aluminum, isopropoxy.bis(ethyl acetoacetate) aluminum, isopropoxy.bis(acetyl acetonate) aluminum, tris(ethyl acetoacetate) aluminum, tris(acetyl acetonate) aluminum and monoacetyl acetonate.bis(ethyl acetoacetate) aluminum and so forth. Among these metal chelate compounds, tri-n-butoxy(ethyl acetoacetate) zirconium, diisopropoxy.bis(acetyl acetonate) titanium, diisopropoxy(ethyl acetoacetate) aluminum and tris(ethyl acetoacetate) aluminum are preferred. One kind of these metal chelate compounds can solely be used or two or more kinds thereof can be used in combination. Further, partial hydrolysates of these metal chelate compounds can also be used.

(2) Organic Metal Compounds

Although preferred organic metal compounds are not particularly limited, organic transition metal compounds are preferred because of their high activity. Among these, tin compounds are particularly preferred since their stability and activity are favorable. Specific examples of these compounds include organic tin compounds including carboxylic acid type organic tin compounds such as (C₄H₉)₂Sn(OCOC₁₁H₂₃)₂, (C₄H₉)₂Sn(OCOCH═CHCOOC₄H₉)₂, (C₈H₁₇)₂Sn(OCOC₁₁H₂₃)₂, (C₈H₁₇)₂Sn(OCOCH═CHCOOC₄H₉)₂ and Sn(OCOCC₈H₁₇)₂; mercaptide type or sulfide type organic tin compounds such as (C₄H₉)₂Sn(SCH₂COOC₈H₁₇)₂, (C₈H₁₇)₂Sn(SCH₂CH₂COOC₈H₁₇)₂, (C₈H₁₇)₂Sn(SCH₂COOC₁₂H₂₅)₂,

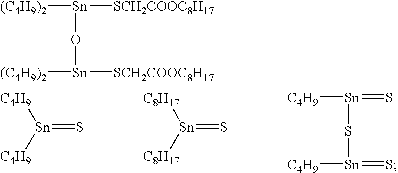

(C₄H₉)₂SnO, (C₈H₁₇)₂SnO and reaction products of an organic tin oxide such as (C₄H₉)₂SnO and (C₈H₁₇)₂SnO and an ester compound such as ethyl silicate, dimethyl maleate, diethyl maleate and dioctyl phthalate, and so forth.

(3) Metal Salts

As the metal salts, alkaline metal salts of organic acids (for example, sodium naphthenate, potassium naphthenate, sodium octanoate, sodium 2-ethylhexanoate, potassium laurate etc.) are preferably used.

The proportion of the sol-gel catalyst compound in the composition is 0.01-50% by weight, preferably 0.1-50% by weight, more preferably 0.5-10% by weight, based on the alkoxysilane, which is a raw material of the sol solution.

Solvents used in the sol-gel reaction will be explained below. The solvents allow all ingredients in the sol solution to be uniformly mixed, thereby make it possible to prepare solid matter in the composition of the present invention and use various coating methods, and improve dispersion stability and storage stability of the composition. These solvents are not particularly limited so long as they can achieve the aforementioned objects. Preferred examples of the solvents include, for example, water and organic solvents showing high water-miscibility.

Examples thereof include tetrahydrofuran, dimethoxyethane, formic acid, acetic acid, methyl acetate, alcohols (methanol, ethanol, n-propyl alcohol, isopropyl alcohol, tert-butyl alcohol), ethylene glycol, diethylene glycol, triethylene glycol, ethylene glycol monobutyl ether, acetic acid ethylene glycol monoethyl ether, acetone, N,N-dimethylformamide, N,N-dimethylacetamide, dimethyl sulfoxide and so forth.

In order to adjust the sol-gel reaction rate, organic compounds that can constitute multidentate ligands may be added to stabilize the metal alkoxide. Examples thereof include β-diketones and/or β-ketoesters and alkanolamines.

Specific examples of the β-diketones and/or β-ketoesters include acetylacetone, methyl acetoacetate, ethyl acetoacetate, n-propyl acetoacetate, isopropyl acetoacetate, n-butyl acetoacetate, sec-butyl acetoacetate, tert-butyl acetoacetate, 2,4-hexanedione, 2,4-heptanedione, 3,5-heptanedione, 2,4-octanedione, 2,4-nonanedione, 5-methylhexanedione and so forth. Among these, ethyl acetoacetate and acetylacetone are preferred, and acetylacetone is particularly preferred. One kind of these β-diketones and/or β-ketoesters can solely be used, or two or more kinds of these can be used in combination.

When the aforementioned metal chelate compounds are used as sol-gel catalysts, these compounds that can be multidentate ligands can also be used to adjust the reaction rate.

In the present invention, an organic-inorganic hybrid material obtained by the sol-gel method may be further provided on an inorganic thin film layer formed on a base film. As the inorganic thin film layer, a dense inorganic coating thin film obtained by the sol-gel method is preferred.

A method for coating a sol-gel reaction composition will be described below. A sol solution can be used to form a thin film on a transparent film by using a coating method such as curtain flow coating, dip coating, spin coating or roll coating. In this case, the timing of hydrolysis may be at any time during the production process. For example, there can be suitably used a method in which a solution having a required composition is hydrolyzed and partially condensed to prepare a desired sol solution beforehand, and then it is applied and dried, a method in which a solution having a required composition is prepared and applied and dried while being simultaneously hydrolyzed and partially condensed, a method in which, after a solution is coated and primarily dried, a water-containing solution necessary for hydrolysis is overlaid to attain the hydrolysis, and so forth. Further, various application methods can be used. When productivity is emphasized, a method in which the discharge flow rates of a lower layer coating solution and an upper layer coating solution are adjusted in a slide geeser having multiple discharge ports so that required amounts of the solutions should be obtained, and the formed multilayer flows are continuously placed on a support and dried (simultaneous multilayer coating method) is preferred.

Although temperature for drying after the coating is not particularly limited so long as it is in such a range that the support should not be deformed, it is preferably 180° C. or lower, more preferably 30-150° C., particularly preferably 50-130° C.

In order to make the film after the coating and drying further denser, irradiation of energy beam may be performed. Although type of the irradiation beam is not particularly limited, irradiation of ultraviolet rays, electron beams or microwaves can be particularly preferably used in view of influence on deformation and degeneration of a support. The irradiation intensity is 30-500 ml/cm², particularly preferably 50-400 mJ/cm². The irradiation temperature may be selected from the range of from room temperature to the temperature at which the support begins to deform without any particular limitation, and it is preferably 30-150° C., particularly preferably 50-130° C.

Other functional layers may be provided and laminated on the coating layers obtained as described above. Examples of such functional layers include, for example, a protective layer and the like.

The gas barrier film of the present invention can be used for various purposes. For example, display devices such as organic electroluminescent devices and liquid crystal devices can be fabricated by using the gas barrier film of the present invention.

When the gas barrier film of the present invention is used for EL devices or the like, it is preferable to use the film according to the descriptions of Japanese Patent Laid-Open Publication Nos. 11-335661, 11-335368, 2001-192651, 2001-192652, 2001-192653, 2001-335776, 2001-247859, 2001-181616 and 2001-181617, Japanese Patent Application Nos. 2001-58834, 2001-58835, 2001-89663 and 2001-334858.

That is, the gas barrier film of the present invention can be used as a base film and/or a protective film for forming an EL device. In such a case, it is preferable to use the coating layer obtained by the sol-gel method on the EL layer side, i.e., the side that is not brought into contact with outside air.

### EXAMPLES

Characteristics of the present invention will be more specifically explained with reference to the following examples, comparative examples and test examples. The materials, amounts, ratios, types and procedures of treatments and so forth shown in the following examples can be suitably changed unless such changes depart from the purpose of the present invention. Accordingly, the scope of the present invention should not be construed as limited to the following specific examples.

### Example 1

### Production of Gas Barrier Film of the Present Invention

(Preparation of Support)

A polyethylene-2,6-naphthalate polymer was melted at 300° C., then extruded from a T-die, vertically and horizontally stretched and thermally fixed to obtain Film A having a thickness of 100 μm.

Further, synthetic fluorine tetrasilicon mica (SOMASIF MTE, CO-OP Chemical) was mixed with a cycloolefin polymer resin (ZEONOR 1600R, Zeon Corporation) in an amount of 10 parts by weight per 100 parts by weight of the cycloolefin polymer resin, kneaded and extruded at 270° C. by using a double screw extruder (Rheomix 600P/PTW25, HAAKE, Germany) to obtain Film B having a thickness of 200 μm.

The glass transition temperatures of these films were measured by DSC. The glass transition temperature of Film A was 115° C., and that of Film B was 168° C.

Further, the linear thermal expansion coefficients of these films were obtained by TMA. The linear thermal expansion coefficient of Film A was 13 ppm/° C., and that of Film B was 35 ppm/° C.

These films were subjected to corona discharge treatment to obtain supports for coating.

(Formation of Inorganic Coating Layer and Organic-Inorganic Hybrid Coating Layer by Sol-Gel Method)

A mixture of 4.17 g of tetraethoxysilane, 4.8 g of 1-propanol and 1.06 g of water was added with 0.2 ml of 0.1 mol/L hydrochloric acid and stirred at room temperature for 2 hours. In an amount of 2.5 g of this reaction mixture was added with 4.8 g of 1-propanol. This mixture was applied to Films A and B mentioned above by using a wireless bar. Then, the mixture was dried at 120° C. for 5 minutes to obtain an inorganic coating layer having a film thickness of about 100 nm.

In an amount of 8 g of ethylene/vinyl alcohol copolymer (SOARNOL D2908, Nippon Synthetic Chemical Industry) was dissolved in a mixed solvent of 118.8 g of 1-propanol and 73.2 g of water at 80° C. In an amount of 10.72 g of this solution was added and mixed with 2.4 ml of 2 mol/L hydrochloric acid. This solution was added dropwise with 1 g of tetraethoxysilane with stirring. After the dropping, the solution was further stirred for 30 minutes. This mixture was applied to Films A and B coated as described above by using a wire bar. Then, the mixture was dried at 120° C. for 5 minutes to form an organic-inorganic hybrid coating layer having a film thickness of about 1 μm.

By the above operations, coated samples having a laminated structure of the inorganic coating layer and the organic-inorganic hybrid coating layer on Films A and B as supports were obtained. These samples were designated as Sample A and Sample B.

### Comparative Example 1

### Production of Gas Barrier Film for Comparison

An inorganic coating layer and an organic-inorganic hybrid coating layer were similarly formed by using a polyethylene terephthalate (PET) film having a thickness of 100 μm instead of Film A used in Example 1. The linear thermal expansion coefficient of the PET was 20 ppm/° C., which was relatively low. However, its glass transition temperature was about 70° C., and hence the PET was softened during the production of the sample, resulting in poor smoothness of the film. This sample was designated as Comparative Sample A.

Further, an inorganic coating layer and an organic/inorganic hybrid coating layer were similarly formed by using a film consisting of ZEONOR alone (thickness: 100 μm) instead of Film B used in Example 1. Although the glass transition temperature of ZEONOR is as high as 163° C., its linear thermal expansion coefficient is 60 ppm/° C., which is relatively high. This sample was designated as Comparative Sample B.

### Test Example 1

### Measuring Test of Gas Barrier Property

The gas transmission rates of the gas barrier films produced in Example 1 and Comparative Example 1 were measured by the MOCON method. The oxygen transmission rate was measured under conditions of 23° C. and 0% of relative humidity. The water vapor transmission rate was measured under conditions of 23° C. and 90% of relative humidity. The results are shown in Table 1.

TABLE 1

| | Oxygen | Water vapor |
|---|---|---|
| | transmission rate | transmission rate |
| Sample | (m1/m² · day · atm) | (g/m² · day) |
| A | 0.04 | 0.04 |
| B | 0.02 or lower | 0.02 or lower |
| Comparative A | 0.06 | 0.06 |
| Comparative B | 0.04 | 0.04 |

### Example 2

### Production of Organic EL Device of the Present Invention

Sample B was introduced into a vacuum chamber, and a transparent electrode made of an IXO thin film having a thickness of 0.2 μm was formed by DC magnetron sputtering using an IXO target. An aluminum lead wire was connected to the transparent electrode (IXO) to form a laminated structure.

An aqueous dispersion of polyethylene dioxythiophene/polystyrene sulfonic acid (Baytron P, BAYER, solid content: 1.3 weight %) was applied on the surface of the transparent electrode by spin coating and vacuum-dried at 150° C. for 2 hours to form a hole transporting organic thin film layer having a thickness of 100 nm. This was designated as Substrate X.

Further, a coating solution for a light-emitting organic thin film layer having the following composition was applied on one side of a temporary support made of polyethersulfone having a thickness of 188 μm (SUMILITE FS-1300, Sumitomo Bakelite) by using a spin coater and dried at room temperature to form a light-emitting organic thin film layer having a thickness of 13 nm on the temporary support. This was designated as Transfer Material Y.

| | | |
|---|---|---|
| Polyvinyl carbazole | 40 | parts by weight |
| (Mw = 63000, Aldrich) | | |
| Tris (2-phenylpyridine) iridium | 1 | part by weight |
| complex (Ortho-metalated complex) | | |
| Dichloroethane | 3200 | parts by weight |

The light-emitting organic thin film layer side of Transfer Material Y was overlaid on the upper surface of the organic thin film layer of Substrate X, heated and pressurized at 160° C., 0.3 MPa and 0.05 m/min by using a pair of heat rollers, and the temporary support was delaminated to form a light-emitting organic thin film layer on the upper surface of Substrate X. This was designated as Substrate XY.

Further, a patterned mask for vapor deposition (mask providing a light-emitting area of 5 mm×5 mm) was set on one side of a polyimide film (UPILEX-50S, Ube Industries) cut into a 25-mm square and having a thickness of 50 μm, and Al was vapor-deposited in an atmosphere under reduced pressure of about 0.1 mPa to form an electrode having a film thickness of 0.3 μm. Al₂O₃ was vapor-deposited in the same pattern as that of the Al layer by DC magnetron sputtering using an Al₂O₃ target to obtain a film thickness of 3 nm. An aluminum lead wire was connected to the Al electrode to form a laminated structure. A coating solution for an electron transporting organic thin film layer having the following composition was applied on the obtained laminated structure by using a spin coater and vacuum-dried at 80° C. for 2 hours to form an electron transporting organic thin film layer having a thickness of 15 nm on LiF. This was designated as Substrate Z.

| | |
|---|---|
| Polyvinyl butyral | 10 parts by weight |
| (Mw = 2000, 2000L produced by | |
| Denki Kagaku Kogyo) | |
| Electron transporting compound | 20 parts by weight |
| having the following structure | |
| 1-Butanol | 3500 parts by weight |

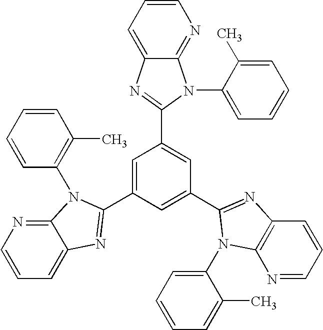

Substrate XY and Substrate Z were stacked so that the electrodes should face each other via the light-emitting organic thin film layer between them, heated and pressurized at 160° C., 0.3 MPa and 0.05 m/min by using a pair of heat rollers to obtain Organic EL Device 1.

### Comparative Example 2

### Production of Organic EL Device for Comparison

Organic EL Devices 2 and 3 were obtained in the same manner as in Example 2 except that Comparative Sample A and Comparative Sample B were used as supports instead of Sample B in the production of Substrate X in Example 2.

### Test Example 2

### Performance Test of Organic EL Device

DC voltage was applied to the obtained Organic EL Devices 1, 2 and 3 by using Source-Measure Unit Type 2400 (Toyo Corporation) to allow them to emit light. Device 1 favorably emitted light. Device 2 had many defects and could not achieve favorable light emission. Device 3 emitted light relatively favorably.

One month after Devices 1 and 3 were produced, they were similarly allowed to emit light. While favorable light emission was similarly observed in Device 1, there were more defects in Device 3. Although the cause therefor was unclear, it is estimated that, since a support having a high linear thermal expansion coefficient was used in Device 3, favorable adhesion could not be achieved.

The present disclosure relates to the subject matter contained in Japanese Patent Application No. 188063/2002 filed on Jun. 27, 2002, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A gas barrier film having an inorganic coating layer formed by the sol-gel method or an organic-inorganic hybrid coating layer formed by the sol-gel method on a transparent base film having a glass transition temperature of 100° C. or higher and a linear thermal expansion coefficient of 40 ppm/° C. or lower.

2. The gas barrier film according to claim 1 having an organic-inorganic hybrid coating layer formed by the sol-gel method on a transparent base film having a glass transition temperature of 100° C. or higher and a linear thermal expansion coefficient of 40 ppm/° C. or lower.

3. The gas barrier film according to claim 1 having an inorganic coating layer formed by the sol-gel method and an organic-inorganic hybrid coating layer formed by the sol-gel method on a transparent base film having a glass transition temperature of 100° C. or higher and a linear thermal expansion coefficient of 40 ppm/° C. or lower.

4. The gas barrier film according to claim 1 having an inorganic thin film layer and an organic-inorganic hybrid coating layer formed by the sol-gel method on a transparent base film having a glass transition temperature of 100° C. or higher and a linear thermal expansion coefficient of 40 ppm/° C. or lower.

5. The gas barrier film according to claim 4, wherein the inorganic thin film layer is an inorganic coating layer formed by the sol-gel method.

6. The gas barrier film according to claim 1, wherein the base film has a glass transition temperature of 120° C. or higher.

7. The gas barrier film according to claim 1, wherein the base film has a glass transition temperature of 150° C. or higher.

8. The gas barrier film according to claim 1, wherein the base film has a linear thermal expansion coefficient of 20 ppm/° C. or lower.

9. The gas barrier film according to claim 1, wherein the base film is made of a material selected from the group consisting of polyethylene naphthalate, polycarbonate, cycloolefin polymer, polyalylate and polyethersulfone.

10. The gas barrier film according to claim 1, wherein the base film contains an inorganic layered compound.

11. The gas barrier film according to claim 10, wherein the weight ratio of the inorganic layered compound and a resin contained in the base film is preferably 1/100 to 100/20.

12. The gas barrier film according to claim 10, wherein the inorganic layered compound contains an organic cation.

13. The gas barrier film according to claim 12, wherein the organic cation contains alkylammonium ions containing a long-chain alkyl group.

14. The gas barrier film according to claim 12, wherein the organic cation is contained in an amount of 0.05 to 3 equivalents relative to the cation exchange capacity of the inorganic layered compound.

15. The gas barrier film according to claim 12, wherein the base film has a laminated structure of an inorganic thin film layer and organic-inorganic hybrid coating layer formed by the sol-gel method on the base film.

16. A substrate for a display having the gas barrier film according to claim 1.

17. A display device having the gas barrier film according to claim 1.

18. An organic electroluminescent device having the gas barrier film according to claim 1.

19. A liquid crystal device having the gas barrier film according to claim 1.

20. A method for preparing a gas barrier film having an inorganic coating layer or an organic-inorganic hybrid coating layer on a transparent base film having a glass transition temperature of 100° C. or higher and a linear thermal expansion coefficient of 40 ppm/° C. or lower, which comprises the step of forming the inorganic coating layer on the transparent base film by hydrolizing and polycondensating a metal alkoxide, or the step of forming the organic-inorganic hybrid coating layer on the transparent base film by hydrolizing and polycondensating a metal alkoxide in the presence of a resin.

21. A method for preparing a gas barrier film having an inorganic coating layer and an organic-inorganic hybrid coating layer on a transparent base film having a glass transition temperature of 100° C. or higher and a linear thermal expansion coefficient of 40 ppm/° C. or lower, which comprises the step of forming the inorganic coating layer on the transparent base film by hydrolizing and polycondensating a metal alkoxide, and the step of forming the organic-inorganic hybrid coating layer on the transparent base film by hydrolizing and polycondensating a metal alkoxide in the presence of a resin.
